(19) United States
(12) Patent Application Publication
(10) Pub. No.: US 2023/0302754 A1
(43) Pub. Date: Sep. 28, 2023

(54) METHOD AND APPARATUS FOR PROVIDING COOLANTS AND/OR EXTRACTANTS FOR AT LEAST ONE PRESS, AND PRESSING APPARATUS

(71) Applicant: Harburg-Freudenberger Maschinenbau GmbH, Hamburg (DE)

(72) Inventors: Maik BILLE, Hamburg (DE); Jan IKELS, Hamburg (DE)

(21) Appl. No.: 18/127,137

(22) Filed: Mar. 28, 2023

(30) Foreign Application Priority Data
Mar. 28, 2022 (DE) 10 2022 107 203.7

(51) Int. Cl. B30B 15/34

(52) U.S. Cl. CPC B30B 15/34

(57) ABSTRACT

A method and an apparatus for providing coolants and/or extractants for at least one press, and to a pressing apparatus. The reliability and accuracy of the feed of a coolant and/or extractant to an extraction press that are needed for large-scale industrial use can be achieved by the combination of a storage device, a metering device and a distributing device.

### CROSS-REFERENCE TO RELATED APPLICATIONS

The present application claims priority of DE 10 2022 107 203.7, filed Mar. 28, 2022, the priority of this application is hereby claimed, and this application is incorporated herein by reference.

### BACKGROUND OF THE INVENTION

The invention relates to an apparatus for providing coolants and/or extractants for at least one press, in particular for presses in the sense of extraction presses for separating solid and liquid constituents of a pressing material.

The invention also relates to a pressing apparatus, in particular in the sense of an extraction press, having an apparatus for providing coolants and/or extractants.

The invention furthermore relates to a method for providing coolants and/or extractants for at least one press, in particular for presses in the context of extraction presses for separating solid and liquid constituents of a pressing material.

Mechanical pressing operations in an extraction press, for example in the form of a screw press, produce heat which sometimes increases the temperature of the press cake and/or the liquid that has been pressed out to such an extent that it is necessary to accept quality losses. In addition, for example in the case of the extraction of cooking oils using an extraction press, it is fundamentally desirable for there to be as low as possible a residual fat content in the press cake, which conversely means a high oil yield.

In the case of the separation of liquid and solid constituents of a pressing material, in particular in the case of pressing oils out of oil seeds, using an extraction press, it is already known to add an extractant and/or coolant in addition to the purely mechanical extraction of the pressing material.

This makes it possible to implement the pressing operation at lower temperatures, with the result that the quality of the products can be increased. The higher viscosity of oils at lower temperatures, however, makes it more difficult for the oil to flow out of the extraction press. The use of extractants can counteract this problem.

For example, the use of supercritical CO2, isopentane or n-butane as extractant is known.

According to DE 10 2005 109 294 A1, supercritical carbon dioxide, which, besides ensuring a considerable reduction in the viscosity of the oil, also ensures cooling of the oil and of the press cake, is fed to the pressing material in a screw press as extractant.

Consideration is given to liquid nitrogen, for example, as pure coolant.

Known processes and apparatuses in the case of a pressing operation assisted by supercritical carbon dioxide encounter great difficulties in terms of the constant and faultless supply of supercritical carbon dioxide to the extraction press or to multiple connected extraction presses. As a result, use on a large industrial scale in the order of magnitude of more than 5 t of oil seeds processed per day is presently not possible.

### SUMMARY OF THE INVENTION

It is therefore an object of the invention to provide an improved apparatus for providing coolants and/or extractants for at least one press.

Another object of the invention is to provide an improved pressing apparatus.

Yet another object of the invention is to specify an improved method for providing coolants and/or extractants for at least one press.

The features disclosed below of an apparatus for providing coolants and/or extractants for at least one press, of a pressing apparatus, and of a method for providing coolants and/or extractants for at least one press are part of the invention in all feasible combinations.

In embodiments of the invention, use is made, for example, of carbon dioxide, isopentane or n-butane as extractant or nitrogen as pure coolant.

According to the invention, the functional elements—distributing device, metering device and storage device—are combined with one another in an apparatus for providing coolant and/or extractant, in order to realize a reliable supply that can be set precisely enough of a coolant and/or extractant to at least one press on a large industrial scale.

The storage device comprises a reservoir for the coolant and/or extractant, for example a tank, and is connected to a pressure regulating device in order to set the required pressure of the coolant and/or extractant for the intended use.

In most applications, a feed of coolant and/or extractant in the liquid state is desired. Depending on the respective intended feed temperature of the coolant and/or extractant, the result, depending on the respective evaporation temperature, is a minimum pressure in order that said coolant and/or extractant does not evaporate before it is fed into the at least one press.

In embodiments of the invention, the reservoir for the coolant and/or extractant has a cooling apparatus for cooling the stored coolant and/or extractant.

In preferred embodiments of the invention, said cooling apparatus has a condensing apparatus, in which the cooling apparatus is integrated. In certain embodiments of the invention, the condensation apparatus is integrated in or at least connected to the reservoir.

In embodiments of the invention, the pressure regulating device has a single-stage or multiple-stage design and has at least one high-pressure pump.

In embodiments of the invention, the high-pressure pump is configured to provide a starting pressure in a range from approximately 100 to 350 bar.

Since the amount of coolants and/or extractants necessary for supplying multiple presses at the required pressure is usually not possible with individual available high-pressure pumps, since the throughput of the pumps falls as the pressure difference between the input and output of the high-pressure pump increases, in the multiple-stage embodiments of the invention at least two pumps are connected one downstream of another, with the result that each individual pump must produce only some of the pressure difference required overall between the storage pressure of the coolant and/or extractant in the corresponding storage device. Correspondingly, the high-pressure pumps can realize higher throughputs.

In alternative embodiments of the invention, high-pressure pumps are used in a parallel connection in order to realize the necessary throughput.

In further embodiments of the invention, the combination of pumps/high-pressure pumps connected one downstream of another and connected in parallel is also possible.

In preferred embodiments of the invention, the pressure regulating device has at least one pressure regulating circuit, in order to regulate the pressure in at least one stage to a pressure target value. To that end, the corresponding pressure regulating circuit has a pressure measuring device for measuring a pressure measured value and a pressure controlling device, by means of which it is possible to actuate the at least one assigned high-pressure pump and/or at least one regulating valve in order to set the pressure measured value to the pressure target value.

In preferred embodiments of the invention, the pressure line for the extractant and/or coolant is connected downstream of the first stage of the pressure regulating device with a return line to the extractant and/or coolant tank.

This makes it possible to solve two technical problems. Firstly, the at least one high-pressure pump to be started up needs to be slowly cooled down, in the course of which an undesirable gas phase of the extractant and/or coolant is produced. This gas phase can then be guided back into the tank and condense there or in a separate condensing device, and thus be converted back to the liquid phase again. Secondly, the return makes it possible to very quickly and variably remove the extractant and/or coolant from one or more presses to be supplied, without it being necessary to regulate the at least one high-pressure pump continuously on the basis of the actual requirement. Any adjustment of the high-pressure pump or the high-pressure pumps runs the risk of the extractant and/or coolant undesirably converting to the gas phase owing to the variable pressure or temperature values, with the result that it is desirable to operate the high-pressure pump or high-pressure pumps as continuously as possible.

Accordingly, in many embodiments of the invention, the starting pressure of the pressure regulating device is at least finely set using at least one regulating valve, since in this way frequent adaptation of the actuator of the at least one high-pressure pump is not necessary. Preferably, the regulating valve is in the form of a regulatable non-return valve or combined with a non-return valve in a series connection, in order to prevent a backflow of coolant and/or extractant.

In embodiments of the invention, the return line is connected to the pressure line via a pressure-relief valve, with the result that the coolant and/or extractant flows into the return line at a pressure above the pressure threshold value of the pressure-relief valve.

In particularly preferred embodiments of the invention, the pressure-relief valve is additionally switchable, so that the valve can be opened or closed on the basis of events.

In particularly preferred embodiments, the line system for the coolant and/or extractant is in the form of an annular line system at least in the region of the tank/of the reservoir and at least in parts of the pressure regulating device.

As a result, it is possible to connect fundamentally any desired number of extractors for the coolant and/or extractant to the apparatus for providing coolants and/or extractants without it being necessary to install further high-pressure pumps, no coolant and/or extractant is undesirably released by the return of the coolant and/or extractant to the tank upon startup or in the event of faults, the components necessary for metering the coolant and/or extractant to the individual extractors are used together, and as a result the number of components is reduced while maintaining the same flexibility and variability. The latter is additionally associated with higher installation and operational reliability, since use is made of fewer components with the potential for faults.

In advantageous embodiments of the invention, at least one outlet valve, via which extractant and/or coolant can be drained out of the pressure line upon startup or in the event of faults, is integrated in the pressure regulating device.

In preferred embodiments of the invention, the at least one outlet valve can be switched depending on temperature and/or pressure.

In preferred embodiments of the invention, the desired feed temperature of the coolant and/or extractant can be set using a temperature regulating device. Depending on the coolant and/or extractant provided, the temperature can be increased or decreased using the temperature regulating device, which has, for example, a heat exchanger and/or a heater.

Preferably, the temperature regulating device has a temperature measuring device and additionally a heat exchanger and/or a heater, which are/is can be actuated by a temperature controlling device on the basis of the deviation of the temperature measured value from the temperature target value in a manner corresponding to the setting of the temperature to the target value.

In this respect, the temperature can be regulated preferably depending on the oil seed to be processed, the temperature of the oil seed in the press and/or the throughput.

In preferred embodiments of the invention, the metering device for the coolant and/or extractant is in the form of a regulating section.

Particularly preferably, the coolant and/or extractant is metered by regulating the throughflow. To that end, the metering device has a throughflow measuring device and a throughflow regulating valve, which can be set using a metering controller on the basis of the deviation of the throughflow measured value from the throughflow target value in a manner corresponding to the setting of the throughflow to the target value.

In preferred embodiments of the invention, the pressure of the coolant and/or extractant is kept stable in the region of the metering device by means of a pressure maintaining valve or pressure-relief valve.

The apparatus for providing coolants and/or extractants is connected to at least one extraction press via the distributing device for the purpose of feeding the coolant and/or extractant. To that end, the distributing device has a corresponding line system.

Preferably, various extraction presses are attached to the distributing device each by way of at least one dedicated feed line, it particularly preferably being the case that at least one shut-off valve is assigned to each extraction press, with the result that the feed of coolant and/or extractant can be turned on or off individually for each connected extraction press by corresponding actuation of the shut-off valve.

In advantageous embodiments of the invention, at least one separate supply line connected to a common pressure regulating device is provided for each press to be supplied. In embodiments of the invention, individual metering devices and, if appropriate, individual temperature regulating devices are provided for each supply line, in order to be able to set the corresponding parameters individually for each press.

In the region of the extraction chambers of the extraction presses, also referred to as strainer cage in the case of screw presses, the feed lines open out in nozzles, which introduce the extractant into the respective extraction chamber.

With regard to the use of supercritical carbon dioxide as extractant, there are two preferred variants according to the invention that can be applied depending on the installation size.

According to the first variant, which is configured for typical use quantities of 200-1500 kg carbon dioxide/h, supercritical carbon dioxide is supplied using a high-pressure pump (for example, in the form of a piston pump), which is embedded in an annular line system. Here, the liquid carbon dioxide is discharged from a tank at a pressure of approximately 10-20 bar (g) (relative pressure) at a temperature of approximately −20° C. using a pressure increasing pump. The pressure is increased to approximately 60 bar (g). In the process, it is important that the pressure and temperature are kept slightly below the critical characteristic curve of the carbon dioxide in order to avoid cavitation and bubble formation. Downstream of the pressure increasing pump, a partial flow is fed back to the tank and a partial flow supplies the high-pressure pump in the second stage of the pressure regulating device.

The high-pressure pump increases the pressure to 100-350 bar (g). It is also important in the process that the pressure and temperature are kept slightly below the critical characteristic curve of the carbon dioxide in order to avoid cavitation and bubble formation. Downstream of the high-pressure pump, a partial flow is fed back to the tank and a partial flow supplies the carbon dioxide injection, i.e. the temperature and throughflow regulating section in the respective line of the feed line system.

The pressure in the annular line system is regulated by a pressure regulating valve. A target value is predefined.

When returning the carbon dioxide to the tank, it is important to convert resulting gas formations back into liquid carbon dioxide by re-cooling in or upstream of the tank.

The supercritical state of the carbon dioxide is reached by increasing the temperature in the high-pressure region, preferably in the respective feed line, by increasing the temperature to more than 31° C., preferably to a temperature of more than 35° C.

Particularly preferably, the temperature is at most approximately 60° C.

According to the second variant, which is configured for typical use quantities of 10-200 kg carbon dioxide/h, supercritical carbon dioxide is supplied in one stage using a high-pressure pump (for example, in the form of a piston pump).

Here, the liquid carbon dioxide is discharged from a tank at 10-20 bar (g) at −20° C. using a high-pressure pump (100-350 bar (g)). In the process, it is also important that the pressure and temperature are kept slightly below the critical characteristic curve of the carbon dioxide in order to avoid cavitation and bubble formation. Here, no pressure increasing pump or return to the tank is required.

The throughput is provided by the regulating section. The high-pressure pump regulates the pressure, for example, using a frequency transformer or similar regulating devices.

A pressing apparatus according to the invention has an apparatus according to the invention for providing coolants and/or extractants.

The at least one nozzle for introducing the coolant and/or extractant is arranged in the region of the extraction chamber of the press.

Preferably, the at least one nozzle is arranged in the region of one or more expansion zones, for example in each case downstream of a throttle ring.

The one or more nozzles can both be integrated in the strainer cage from the outside, and be arranged on or in the region of the screw shaft.

In particularly preferred embodiments of the invention, the at least one nozzle is equipped with a non-return valve, in order to prevent the press cake and/or extract from entering the nozzle. This avoids blockage of the at least one nozzle.

In preferred embodiments of the invention, either the apparatus for coolants and/or extractants for at least one press or the press itself has an aspiration system, which can be used to collect the gaseous coolant and/or extractant escaping from the interior space of the press.

Preferably, the aspiration system comprises both the pressed oil space and the press cake space. This active ventilation is necessary in order to reduce the concentration of the exiting coolant and/or extractant, for example carbon dioxide. Undesired flowing out of coolant and/or extractant into the surrounding area of the press is thus prevented, and therefore the safety of individuals working in this area can be ensured.

Particularly preferably, the aspiration system is electrically connected to the apparatus for providing coolants and/or extractants for at least one press, in order that safety is ensured at all times.

In advantageous embodiments of the invention, the aspiration system is equipped with a recovery device for recovering the coolant and/or extractant. For example, recovered coolant and/or extractant can be liquefied using a condensing device and fed back to the reservoir again, with the result that the coolant and/or extractant can be recirculated.

In advantageous embodiments of the invention, a detector for gaseous coolant and/or extractant, for example a carbon dioxide detector, is arranged in the pressing oil space, in order to immediately detect undesired exits of the coolant and/or extractant (for example, owing to cracked lines or a drop in pressing pressure in the CO2 chamber) and to stop or minimize the regulation and supply of the coolant and/or extractant. This connection is preferably done in electrical terms and can directly influence the process.

A method according to the invention for providing coolants and/or extractants for at least one press comprises at least the following method steps:
providing a coolant and/or extractant in a reservoir,
increasing the pressure of the coolant and/or extractant using a pressure regulating device,
setting the temperature of the coolant and/or extractant using at least one temperature regulating device,
metering the coolant and/or extractant using at least one metering device.

In embodiments of the invention, the proportion by weight of the coolant and/or extractant is metered such that the amount fed to a press at most corresponds to the proportion by weight of the extract present in the pressing material.

In preferred embodiments of the invention, the proportion by weight of the coolant and/or extractant is metered such that the amount fed to a press is 50% of the weight of the extract present in the pressing material.

Dissolution of the extractant in the extract to a predominant extent, along with a small excess of extractant for providing a gas pressure, is achieved in that the coolant and/or extractant is fed to the pressing material with a proportion by weight which is approximately 25% to 35% of the weight of the extract present in the pressing material.

A typical pressure range is defined in that the extractant is fed to the pressing material at a pressure of approximately 100 to 350 bar.

In particular, it should be kept in mind that the extractant is fed to the pressing material with a pressure of approximately 150 bar.

Typical operating conditions are defined in that the extract is pressed out with a temperature of approximately 35° C. to 60° C. after the extractant has been fed.

Owing to the friction energy generated by the mechanical pressing, a temperature range is generally set in such a way that the extract is pressed out with a temperature of approximately 40° C. to 45° C. after the extractant has been fed.

A typical mechanical pressing pressure ensures that a mechanical pressing pressure in the range of 200 to 300 bar is generated.

An increased extract yield can be achieved in that the pressing material is subjected to multiple successive pressing-out steps.

In particular, it has proven to be advantageous for the pressing material to be mechanically pre-pressed in a first pressing step.

It is likewise expedient for extractant to be added to the pressing material after the pre-pressing operation, and for the extractant to be at least partially dissolved in the extract.

A typical way of carrying out the method is that, after the extractant has been dissolved in the extract, a pressing-out operation is carried out.

A further increased extract yield can be achieved in that the extract to which the extractant has been added is subjected at least twice to a rise in pressure and to a drop in pressure.

In a preferred embodiment of the method according to the invention, an apparatus according to the invention for providing coolants and/or extractants for at least one press is used.

In the respective embodiments, the further method steps or the details of the method steps correspond to the proper use of the components, disclosed in the course of this description, of the respective embodiments of the apparatus for providing coolants and/or extractants for at least one press.

The interaction of the functional units according to the invention thus enables a constant and faultless supply of coolant and/or extractant to at least one press.

This ensures the positive effects on the pressing result. These effects are furthermore an increase in the deoiling of oil seeds (higher yield), a cooling during the pressing operation and thus retention of the protein solubility in the press cake (higher quality), an increase in the quality of the pressed-out oil (low free fatty acids, reduction in the phosphorus lipids in the oil, retention of the vitamins in the oil, reduction in the bitter substances in the oil depending on the oil seed and application; all depending on the oil seed and application).

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1: shows a schematic illustration of a screw press having an apparatus according to the invention for providing coolants and/or extractants; and

FIG. 2: shows a block diagram of an apparatus according to the invention for providing coolants and/or extractants having a connected press.

### DETAILED DESCRIPTION OF THE INVENTION

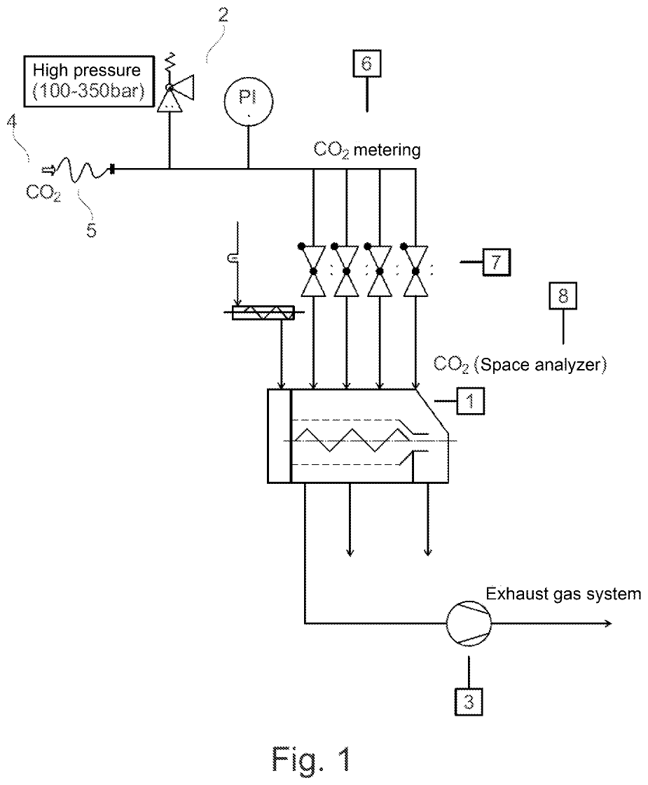

FIG. 1 schematically illustrates a pressing apparatus 1 that is in the form of a screw press and has an apparatus 2 according to the invention for providing coolants and/or extractants. Furthermore, the pressing apparatus 1 is equipped with an aspiration system 3 for extracting exiting gases, in particular gaseous coolant and/or extractant, by suction. In the depicted embodiment of the invention, the extractant is provided by (supercritical) carbon dioxide (CO2).

The apparatus 2 for providing coolants and/or extractants has a reservoir 4 for coolant and/or extractant, a pressure regulating device 5 for setting the desired pressure for the coolant and/or extractant, a metering device 6 for metering the coolant and/or extractant, and a distributing device 7 for distributing the coolant and/or extractant.

In addition, the pressing apparatus 1 is equipped with a detector 8 for gaseous coolant and/or extractant, in the present case in the form of a CO2 detector.

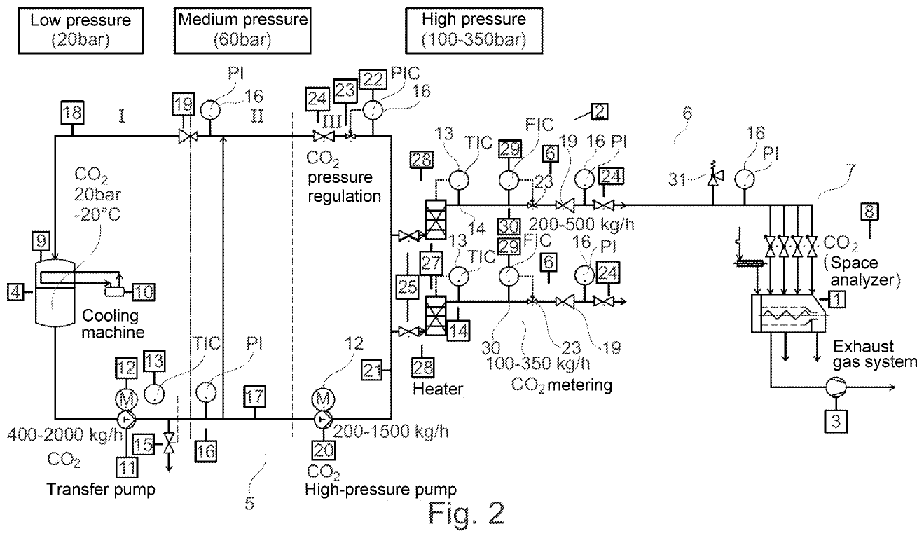

FIG. 2 shows a block diagram of an embodiment according to the invention of an apparatus 2 for providing coolant and/or extractant. It is also the case in this depiction that the extractant is provided by (supercritical) carbon dioxide.

The apparatus 2 for providing coolants and/or extractants has a reservoir 4, in which the coolant and/or extractant is stored at a suitable pressure and a suitable temperature, in the present case at a pressure of approximately 20 bar and a temperature of approximately −20° C. This region is the low-pressure region (I). In many applications it is desirable to store the coolant and/or extractant in a liquid state, and therefore the pressure and temperature must be selected correspondingly.

In the depicted embodiment, the apparatus 2 for providing coolants and/or extractants has a condensing apparatus 9 coupled to the reservoir 4. The condensing apparatus 9 has a cooling apparatus 10, by means of which in particular gaseous coolant and/or extractant can be cooled down for condensation.

Connected to the reservoir 4 via a line is a pressure increasing pump 11, which has a controllable pump drive 12. In the embodiment shown, the pressure increasing pump 11 is designed to handle a throughput of approximately 400 to 2000 kg coolant and/or extractant/h and to increase the pressure of the coolant and/or extractant to approximately 60 bar. This region is the medium-pressure region (II).

A pressure line 17 is connected to the high-pressure pump 11 in the medium-pressure region (II). Furthermore, in the medium-pressure region (II) there is arranged a temperature-controlled regulating circuit 13, which records the temperature of the coolant and/or extractant in the medium-pressure region (II) using the temperature measuring device 14 and, if required, opens an outlet valve 15. For example, this is helpful upon startup or in the event of a fault. Furthermore, pressure measuring devices 16, by means of which compliance with the desired pressure limit values can be checked, are arranged in the medium-pressure region (II).

The pressure line 17 of the medium-pressure region (II) is connected via a pressure-relief valve 19 to a return line 18, which opens out in the condensing device 9 and is connected to the reservoir 4 via said condensing device. A first annular line is thus formed in the medium-pressure region.

Furthermore, a high-pressure pump 20 is connected to the pressure line 17 of the medium-pressure region (II) on the inlet side. In the embodiment shown, the high-pressure pump 20 is designed to handle a throughput of approximately 200 to 1500 kg coolant and/or extractant/h and to increase the pressure of the coolant and/or extractant to approximately 300 bar. This region is the high-pressure region (III). Suitable pressures in the high-pressure region (III) are approximately 100 to 350 bar.

A high-pressure line 21 is connected to the high-pressure pump 20 on the outlet side in the high-pressure region (III). Furthermore, in the high-pressure region (III) there is arranged a pressure regulating circuit 22 which measures the pressure in the high-pressure region (III) using a pressure measuring device 16 and correspondingly regulates the pressure to the target value by actuating a regulating valve 23, via which the coolant and/or extractant can be conducted back to the medium-pressure region (II) to reduce the pressure in the high-pressure region (III). The regulating valve 23 is combined with a non-return valve 24, with the result that, even in the event of a fault at this location, no coolant and/or extractant can flow out of the medium-pressure region (II) into the high-pressure region (III). A second annular line is formed in the medium-pressure region (II) by way of this return.

Two supply lines are connected to the high-pressure line 21 via a respective shut-off valve 25.

Each of the lines has a temperature regulating device 28 for setting the temperature of the coolant and/or extractant and a metering device 6 for setting the amount of coolant and/or extractant that is to be discharged.

The temperature regulating devices 28 have a respective temperature regulating circuit 13, which can determine the temperature of the coolant and/or extractant using a temperature measuring device 4 and correspondingly, in the event of deviations of the temperature measured value from the temperature target value, actuate a heat exchanger 27 for influencing the temperature of the coolant and/or extractant.

In the embodiment shown, the heat exchangers are in the form of heaters with a heating power of 20 kW.

The metering devices 6 each have a throughflow regulating circuit 29, which can determine the throughflow of the coolant and/or extractant using a throughflow measuring device 29 and correspondingly, in the event of deviations of the throughflow measured value from the throughflow target value, actuate a regulating valve 23 for influencing the throughflow of the coolant and/or extractant.

In the embodiment shown, the metering device 6 of a first supply line is designed to meter the throughflow in a range of 200 to 500 kg coolant and/or extractant/h. The metering device 6 of a second supply line is designed to meter the throughflow in a range of 100 to 350 kg coolant and/or extractant/h.

Preferably, at least one separate supply line is provided for each connected press, with the result that the amount of extractant provided in each case can be controlled individually for each press.

In each of the supply lines, downstream of the metering device 6 in a flow direction of the coolant and/or extractant, a pressure-relief valve 19, a pressure measuring device 16 and a non-return valve 24 are arranged. Connected thereto is the distributing device 7, which comprises the corresponding high-pressure lines to the individual presses.

In the embodiment depicted, the distributing device 7 is in the form of a connecting line system between the first supply line of the apparatus 2 for providing coolant and/or extractant and a press 1 that is in the form of a screw press. A safety valve 31 and a pressure measuring device 16 are integrated in the distributing device 7.

The press 1 has four nozzles for introducing the coolant and/or extractant into the pressing space, each of said nozzles being equipped with a non-return valve.

In the embodiment shown, the pressures and temperatures specified are designed for carbon dioxide as extractant. If another coolant and/or extractant is used, they must be adapted correspondingly, if appropriate.

While specific embodiments of the invention have been shown and described in detail to illustrate the inventive principles, it will be understood that the invention may be embodied otherwise without departing from such principles.

We claim:

1. An apparatus for providing coolants and/or extractants for at least one press, comprising: at least one reservoir; a pressure regulating device; a temperature regulating device; and a metering device, wherein the pressure regulating device has a single-stage or multiple-stage form.

2. The apparatus according to claim 1, wherein the pressure regulating device has an at least two stage structure.

3. The apparatus according to claim 1, wherein the pressure regulating device includes at least one pressure increasing pump and at least one high-pressure pump.

4. The apparatus according to claim 1, further comprising an annular line that includes a return line for returning the coolant and/or extractant to the reservoir.

5. The apparatus according to claim 1, wherein the pressure regulating device, at least for fine regulation of pressure, includes a pressure regulating circuit that includes a regulating valve having an actuator configured so the regulating valve is openable to lower and set the pressure to a pressure target value.

6. The apparatus according to claim 1, wherein the metering device includes a throughflow regulating circuit.

7. The apparatus according to claim 1, further comprising at least one individual supply line for each connected press.

8. The apparatus according to claim 7, wherein each supply line has an individual temperature regulating device and an individual metering device.

9. The apparatus according to claim 1, further comprising a condensing device for condensing gaseous coolant and/or extractant.

10. A pressing apparatus, comprising an apparatus for providing coolants and/or extractants according to claim 1.

11. The pressing apparatus according to claim 10, further comprising at least one nozzle for introducing the coolant and/or extractant into a pressing space.

12. The pressing apparatus according to claim 11, wherein the at least one nozzle has a non-return valve.

13. A method for providing coolants and/or extractants for at least one press, comprising the steps of:
providing a coolant and/or extractant in a reservoir;
increasing pressure of the coolant and/or extractant using a pressure regulating device;
setting temperature of the coolant and/or extractant using at least one temperature regulating device; and
metering the coolant and/or extractant using at least one metering device.

14. The method according to claim 13, including using an apparatus for providing coolants and/or extractants, comprising at least one reservoir; a pressure regulating device; a temperature regulating device; and a metering device, wherein the pressure regulating device has a single-stage or multiple-stage form.
